(19) United States
(12) Patent Application Publication
(10) Pub. No.: US 2009/0160828 A1
(43) Pub. Date: Jun. 25, 2009

(54) DISPLAY, DATA CONTROL CIRCUIT THEREOF, AND DRIVING METHOD FOR THE SAME

(75) Inventors: Chun-Fan Chung, Hsinchu (TW); Sheng-Kai Hsu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: AU OPTRONICS CORPORATION, Hsinchu (TW)

(21) Appl. No.: 12/043,972

(22) Filed: Mar. 7, 2008

(30) Foreign Application Priority Data
Dec. 24, 2007 (TW) 96149684

(51) Int. Cl. G09G 5/00; G06F 3/038; G09G 3/34

(52) U.S. Cl. 345/204; 345/98; 345/84

(57) ABSTRACT

A driving method for a display is provided. The display includes a plurality of data lines. The driving method includes the steps of: providing a black frame data output signal, and a trigger signal; receiving at least one of a plurality of normal frame data and a plurality of black frame data from a receiving terminal; when the trigger signal is enabled, and the black frame data output signal is not enabled, outputting the normal frame data from an output terminal when the trigger signal changes status so as to allow the display to display the normal frame; and outputting the black frame from the output terminal when both of the trigger signal and the black frame data output signal are enabled, and when the trigger signal changes status so as to allow the display to display the black frame, and sustaining a status of the receiving terminal.

### CROSS-REFERENCE TO RELATED APPLICATION

This application claims the priority benefit of Taiwan application serial no. 96149684, filed on Dec. 24, 2007. The entirety the above-mentioned patent application is hereby incorporated by reference herein and made a part of specification.

### BACKGROUND OF THE INVENTION

1. Field of the Invention

The present invention generally relates to a driving method for flat panel displays, and more particularly, to a driving method for mini low voltage differential signaling (mini-LVDS) flat panel displays.

2. Description of Related Art

Recently, flat panel displays having the advantages of light weight and small size, have gradually replaced the conventional cathode ray tube (CRT) displays. Typical flat panel displays generally include liquid crystal displays (LCDs), field emission displays (FEDs), plasma display panels (PDPs), etc.

A flat panel display is often desired to have a high resolution and a multiple of gray levels. This correspondingly increases the quantity of data transmission between a sequence controller and a data driver, and therefore causes a drastic increase in number of signal lines, power consumption, and electromagnetic interference (EMI) noise for the data transmission. As such, a mini-LVDS transmission interface has been proposed addressing to the data transmission of flat panel displays.

FIG. 1 is a signal sequence diagram of a conventional mini-LVDS transmission interface. Referring to FIG. 1, in the conventional mini-LVDS transmission interface, after a trigger signal STB is enabled, whenever a clock signal CLK changes from a low status to a high status, a status of a data line D0 must be checked. If, at a time t1, the data line D0 is also enabled when the clock signal CLK is changing from the low status to the high status, and when the data line D0 is secondly disabled (at a time t2), the conventional mini-LVDS transmission interface will wait for the data line D0 to be again enabled. At a time t3, signals transmitted to the data lines D0, D1, . . . , Dn after the data line D0 is detected to be again enabled are formal data signals.

However, the scan line D0 may be interfered by noises or others factors so as to cause a jitter thereby during the period of t2 to t3. The jitter may possibly be construed as a formal data signal and thus causing a misoperation of the display.

### SUMMARY OF THE INVENTION

Addressing to the foregoing problem, the present invention is directed to a driving method for a display, which is adapted for inserting a black frame at any time.

The present invention is also directed to a display and a data control circuit of the display, which flexibly adjust a ratio between black frames and normal frames.

The present invention provides a driving method for a display including a plurality of data lines. The driving method includes the steps of: providing a black frame data output signal BDO, and a trigger signal STB; receiving at least one of a plurality of normal frame data and a plurality of black frame data from a receiving terminal, wherein when the trigger signal is enabled, and the black frame data output signal is not enabled; outputting the normal frame data from an output terminal when the trigger signal changes status so as to allow the display to display the normal frame; and when both of the trigger signal and the black frame data output signal are enabled, outputting the black frame from the output terminal when the trigger signal changes status so as to allow the display to display the black frame, and sustaining a status of the receiving terminal.

The present invention further provides a data control circuit adapted for a display. The data control circuit includes a clock sequence control unit, an input register, and an output register. The clock sequence control unit is provided for receiving a trigger signal, a black frame data output signal, and a plurality of normal frame data. When the trigger signal and the black frame data output signal are not both enabled, the clock sequence control unit controls the output register to output normal frame data when the trigger signal changes its status. Otherwise, when the trigger signal and the black frame data output signal are both enabled, and when the trigger signal changes its status, the clock sequence control unit controls the output register to output black frame data, and maintains the output register unchanged from its present.

The present invention further provides a display. The display includes a data control circuit, a display panel, and a plurality of data lines. The data control circuit is adapted for receiving a trigger signal and a black frame data output signal. The data control circuit is coupled to the display panel via the data lines. According to an embodiment of the present invention, when the trigger signal and the black frame data output signal are not both enabled at the same time, the data control circuit controls the display panel to display a normal frame when the trigger signal changes its status. When the trigger signal and the black frame data output signal are both enabled at the same time, the data control circuit controls the display panel to display a black frame when the trigger signal changes its status.

The present invention determines to display the normal frames or the black frames according to the status of the trigger signal and the black frame data output signal respectively, thus allowing users to adjust a ratio of times between displaying the normal frames and the black frames. Further, the present invention provides an effective solution for the misoperation of displays caused by data lines due to jitters.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a signal sequence diagram of a conventional mini-LVDS transmission interface.

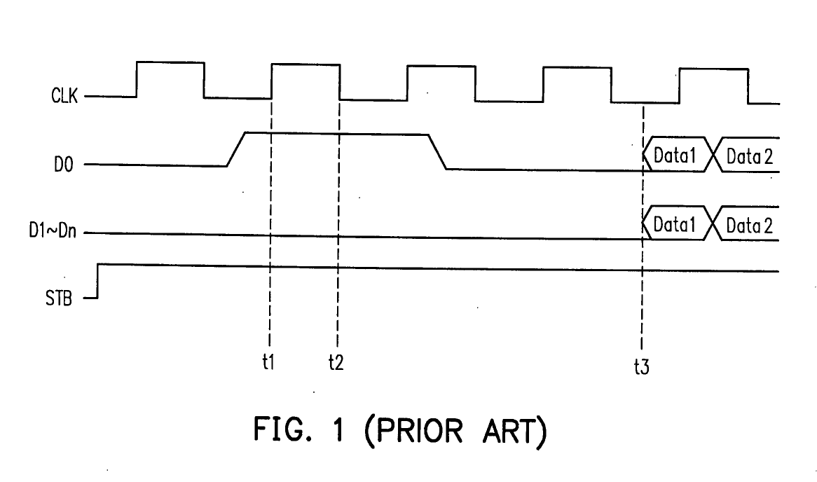

FIG. 2 is systematic block diagram illustrating a display according to an embodiment of the present invention.

FIG. 3 is flow chart illustrating the steps of a driving method for the display of FIG. 2.

FIG. 4 is a signal sequence diagram of a driving method for the display according to a first embodiment of the present invention.

FIG. 5 is a signal sequence diagram of a driving method for the display according to a second embodiment of the present invention.

FIG. 6 is a signal sequence diagram of a driving method for the display according to a third embodiment of the present invention.

FIG. 7 is a signal sequence diagram of a driving method for the display according to a fourth embodiment of the present invention.

FIG. 8 is a signal sequence diagram of a driving method for the display according to a fifth embodiment of the present invention.

FIG. 9 is a signal sequence diagram of a driving method for the display according to a sixth embodiment of the present invention.

FIG. 10 is a signal sequence diagram of a driving method for the display according to a seventh embodiment of the present invention.

FIG. 11 is a signal sequence diagram of a driving method for the display according to an eighth embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

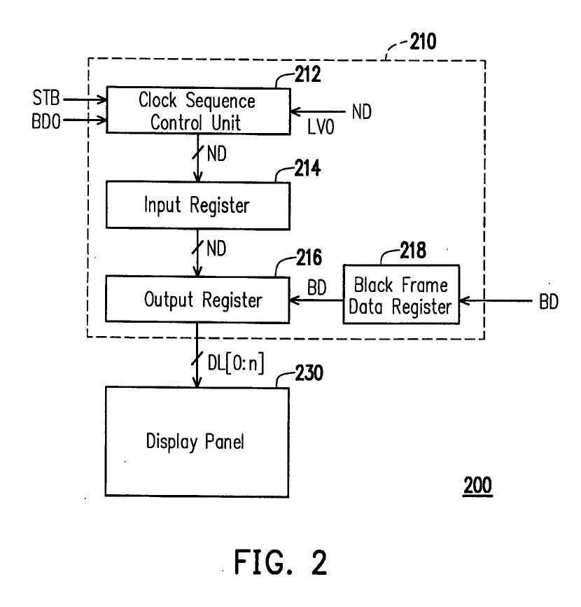

FIG. 2 is systematic block diagram illustrating a display according to an embodiment of the present invention. Referring to FIG. 2, a display 200 includes a data control circuit 210 and a display panel 230. The data control circuit 210 is coupled to the display panel 230 via a plurality of data lines DL[0:n], in which n is a positive integer. In the display 200, the data control circuit 210 is adapted for receiving a trigger signal STB, and a black frame data output signal BDO, and controlling the display panel 230 to display a normal frame or a black frame according to statuses of the trigger signal STB and the black frame data output signal BDO.

The data control circuit 210 at least includes a clock sequence control unit 212, an input register 214, and an output register 216. The clock sequence control unit 212 is coupled to the input register 214, and is adapted for receiving a normal frame data ND via a transmission line LV0, e.g., by serial transmittance. According to other embodiments, the clock sequence control unit 212 may alternatively be adapted for receiving a black frame data BD via the transmission line LV0, which will be discussed below in more details. For convenience of illustration, the transmission line LV0 is exemplified with a single transmission line hereby. However, it should be noted that more transmission lines might be used in practical operation, and serial transmittance is not exclusively designated by the present invention. Further, according to an aspect of the embodiment, the input register 214 is coupled to the output register 216, and the output register 216 is coupled to the display panel 230 via the data lines DL[0:n]. According to a further aspect of the embodiment, the data control circuit 210 further includes a black frame data register 218, provided for storing the black frame data DB, and for transmitting the black frame data DB to the output register 216.

The clock sequence control unit 212 receives the trigger signal STB and the black frame data output signal BDO, and transmits the normal frame data ND to the input register 214. Therefore, the input register 214 transmits the normal frame data ND to the output register 216. In such a way, the clock sequence control unit 212 can control the output register 216 to output the normal frame data ND or the black flame data BD to the display panel 230 according to the statuses of the trigger signal STB and the black frame data output signal BDO.

Although as shown in FIG. 2, the black frame data BD is transmitted to the output register 216 by the black frame data register 218, in other embodiments, when the clock sequence control unit 212 desires the display panel 230 to output a black frame, an externally generated predetermined value can be provided serving as a black frame data, and directly transmitted to the output register 216, and thereby transmitted to the display panel 230 via the data lines DL[0:n].

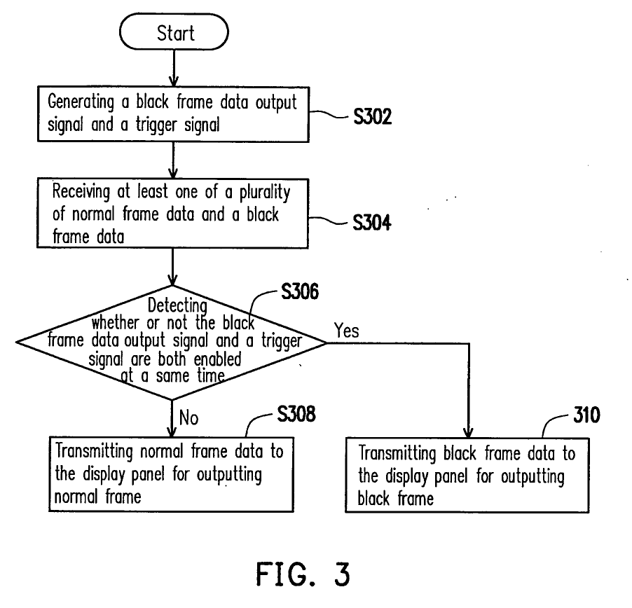

FIG. 3 is flow chart illustrating the steps of a driving method for the display of FIG. 2. Referring to FIGS. 2 and 3 together, at step S302, a black frame data output signal BDO is generated. Thereafter, the clock sequence control unit 212 receives the trigger signal STB and the black frame data output signal BDO, and the input register 214 receives the normal frame data ND, at step S304. In other embodiments, the input register 214 can also receive the black frame data BD.

When the clock sequence control unit 212 receives the trigger signal STB and the black frame data BD, at step S306, whether both of the trigger signal STB and the black frame data output signal BDO are enabled are detected at a detecting time. If, in the detecting time, the trigger signal STB is enabled while the black frame data output signal BDO is not enabled (i.e., the arrow initiated from step S306 remarked as “No”), the clock sequence control unit 212 controls the output register 216 to perform the step S308, in which the normal frame data ND are transmitted to the display panel 230 via the data lines DL[0:n], so as to allow the display panel 230 to display normal frames.

Otherwise, if, at the detecting time, both of the trigger signal STB and the black frame data output signal BDO are enabled (i.e., the arrow initiated from step S306 remarked as “Yes”), the clock sequence control unit 212 controls the output register 216 to perform the step S310, in which the black frame data BD are transmitted to the display panel 230, so as to allow the display panel 230 to display black frames. Meanwhile, the input register 214 stays unaffected by the output register 216, and keeps receiving normal frame data ND from the clock sequence control unit 212.

Different embodiments are to be given herebelow for illustration in more details.

### First Embodiment

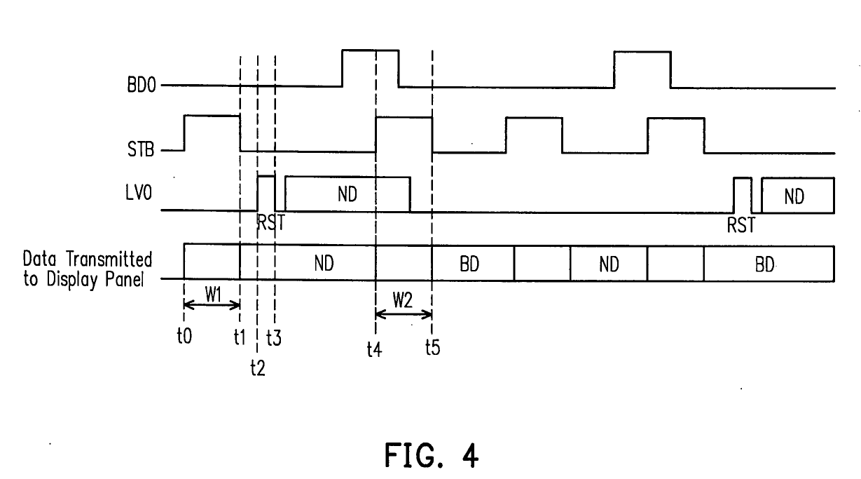

FIG. 4 is a signal sequence diagram of a driving method for the display according to a first embodiment of the present invention. Referring to FIGS. 2 and 4 together, in the current embodiment, if the clock sequence control unit 212 detects that, at the detecting time, e.g., t0, the trigger signal STB is enabled while the black frame data output signal BDO is not enabled, the clock sequence control unit 212 is adapted for waiting for a reset signal RST to be enabled, after the trigger signal STB is disabled, e.g., after t1. In the current embodiment, the period from t0 to t1 of the trigger signal STB is defined as a first operation period W1.

According to an aspect of the embodiment, the action of “waiting for a reset signal RST to be enabled” as described above can be complied with a status switching of the transmission line LV0. For example, if at time t2, the transmission line LV0 is enabled, it can be taken as a reset signal RST being enabled. After the reset signal RST is disabled, e.g., after t3, the clock sequence control unit 212 determines that the next data transmitted immediately after the reset signal and received from the transmission line LV0 would be the normal frame data ND. Then, the clock sequence control unit 12 transmits the normal frame data ND to the input register 214, and the input register 214 transmits the normal frame data ND to the output register 216. In such a way, after the first operation period W1, the output register 216 transmits the received normal frame data ND to the display panel 230 via corresponding data lines respectively, and thus the display panel can display normal frames thereby.

In the current embodiment, a time period from t4 at which the trigger signal STB is enabled to t5 at which the trigger signal STB is disabled is defined as a second operation period W2. If, at another detecting time, for example t4, that the clock sequence control unit 212 detects that the both of the trigger signal STB and the black frame data output signal BDO are enabled, this indicates that the display panel 230 is going to output the black frame. Therefore, when the second operation period W2. terminates, the output register 216 transmits the black frame data BD to the display panel 230 via corresponding data lines, so as to allow the display panel 230 to display the black frame.

### Second Embodiment

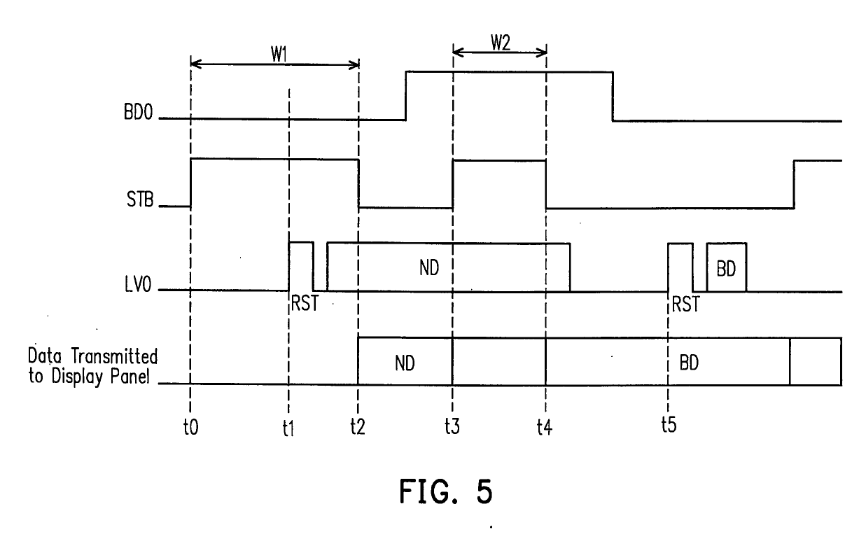

FIG. 5 is a signal sequence diagram of a driving method for the display according to a second embodiment of the present invention. Referring to FIGS. 2 and 5 together, if at the detecting time t0, the clock sequence control unit 212 detects that the trigger signal STB and the black frame data output signal BDO are not both enabled, then the clock sequence control unit 212 determines that the trigger signal STB enters the first operation W1 from t0. Further, after the trigger signal STB being enabled at time t0, the clock sequence control unit 212 waits for the rest signal RST to be enabled.

If at time t1, the reset signal RST is enabled at the transmission line LV0, the clock sequence control unit 212 then determines that the next data transmitted immediately after the reset signal and received from the transmission line LV0 would be the normal frame data ND. Meanwhile,. the clock sequence control unit 212 can transmit the normal frame data ND to the input register 214, and the input register 214 can wait for a while (e.g., waiting until the output register 216 completes the outputting of all data stored therein), and then transmits the normal frame data ND to the output register 216. The output register 216 is adapted for latching the data received from the input register 214 until the first operation period W1 terminates. When the first operation period W1 terminates, the output register 216 transmits the received normal frame data ND to the display panel 230 via the data lines DL[0:n] for displaying the normal frame.

According to an aspect of the embodiment, the black frame data register 218 can be optionally omitted from the data control unit 210. If the black frame data register 218 is omitted, the black frame data BD can be transmitted to the clock sequence control unit 212. The principle of operation is to be illustrated in more details herebelow.

If at another detecting time, e.g., t3, the clock sequence control unit 212 detects that both of the trigger signal STB and the black frame data output signal BDO are enabled, then the clock sequence control unit 212 waits for another reset signal RST. If at time t5, there is another reset signal RST occurred at the transmission lien LV0, the clock sequence control unit 212 determines that the next data transmitted immediately after the reset signal and received from the transmission line LV0 would be the black frame data BD. In this case, the clock sequence control unit 212 transmits the black frame data BD to the input register 214 for temporary storing. Similarly, after a certain while, the input register 214 transmits the black frame data BD to the output register 216. Therefore, the output register 216 temporarily latches the black frame data BD therein.

In the current embodiment, a time period from t3 at which the trigger signal STB is enabled to t4 at which the trigger signal STB is disabled is similarly defined as the second operation period W2. When the second operation period W2. terminates, the output register 216 transmits the black frame data BD to the display panel 230 via corresponding data lines, so as to allow the display panel 230 to display the black frame.

### Third Embodiment

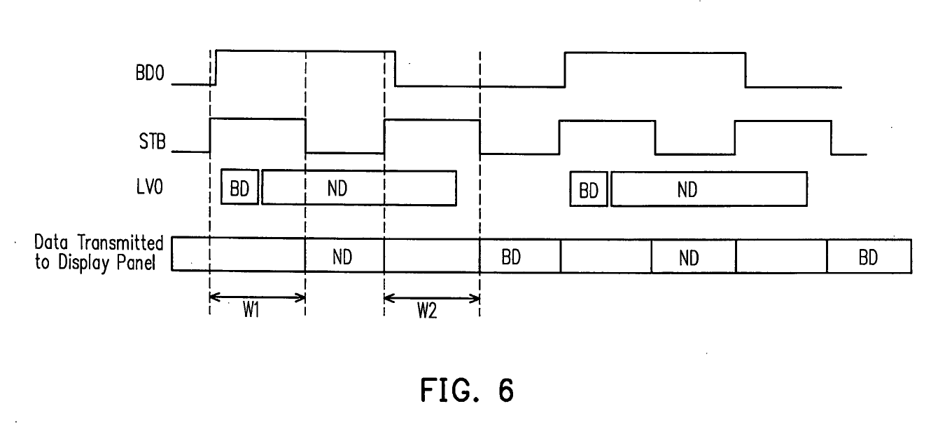

FIG. 6 is a signal sequence diagram of a driving method for the display according to a third embodiment of the present invention. Referring to FIGS. 2 and 6 together, the current embodiment operates based on a similar principle as that of the second embodiment, in which the black frame data register 218 can be omitted. However, the third embodiment differs from the second embodiment in that the clock sequence control unit 212 need not wait twice for the reset signal RST for respectively receiving the normal frame data ND and the black frame data BD. In the current embodiment, data received by the clock sequence control unit 212 after the first reset signal RST expires are sequentially set as black frame data BD and normal frame data ND. In such a way, the input register 214 is adapted to transmit the black frame data BD to the output register 216, and then transmit the normal frame data ND to the output register 216. The output register 216 is adapted to wait for the termination of the second operation period W2, so as to transmit the black frame data BD to the display panel 230; and waiting for the termination of the first operation period W1, so as to transmit the normal frame data ND to the display panel 230. As such, the display panel 230 is also adapted to display black frames and normal frames in sequence.

### Fourth Embodiment

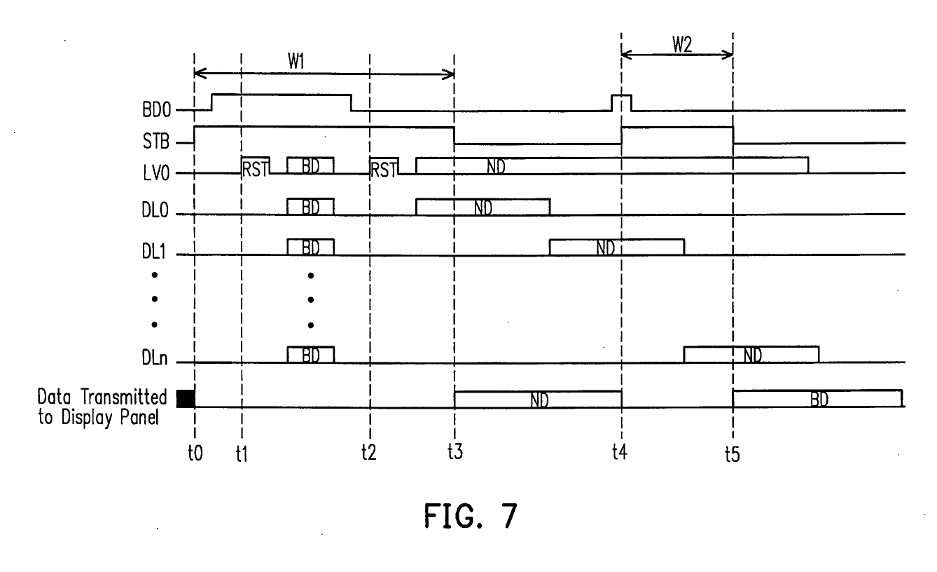

FIG. 7 is a signal sequence diagram of a driving method for the display according to a fourth embodiment of the present invention. Referring to. FIGS. 2 and 7 together, if, at the detecting time t0, the clock sequence control unit 212 detects that the trigger signal STB is enabled while the black frame data output signal BDO is not enabled, then the clock sequence control unit 212 detects a status of the transmission lien LV0 for waiting for the reset signal RST to be enabled. If the clock sequence control unit 212 detects that the reset signal RST is enabled at time t1 on the transmission line LV0, then the clock sequence control unit 212 determines that the next data transmitted immediately after the reset signal on the transmission line LV0 would be the black frame data BD. And therefore, the clock sequence control unit 212 receives the black frame data BD and then transmits the black frame data BD to the input register 214 for temporary storage. After a certain while (waiting for all of data stored in the output register 216 being outputted), the. black frame data BD are transmitted to the output register 216 for temporary storage.

After receiving the black frame data BD, the clock sequence control unit 212 is adapted to wait for the reset signal RST to be enabled again on the transmission line LV0. If at time t2, the reset signal RST is again enabled, the clock sequence control unit 212 then determines that the next data transmitted immediately after the reset signal on the transmission line LV0 would be the normal frame data ND. Similarly, after receiving the normal frame data ND, the clock sequence control unit 212 is adapted to transmit the normal. frame data ND to the input register 214. After waiting a certain while, the input register 214 transmits the normal frame data ND to the output register 216.

The output register 216 transmits the black frame data BE to the data lines DL[0:n] via synchronous transmission, and transmits the normal frame data ND to the data lines DL[0:n] via nonsynchronous transmission.

Further, similar to the foregoing embodiments, a time period from t0 at which the trigger signal STB is enabled to t3 at which the trigger signal STB is disabled is defined as a first operation. period W1, and a time period from t4 at which the trigger signal STB is enabled to t5 at which the trigger signal STB is disabled is defined as a second operation period W2. When the first operation period W1 terminates, the normal frame data ND is transmitted to the display panel 230 so as to allow the display panel 230 to display the normal frame. Correspondingly, when the second operation period W2 terminates, the black frame data BD is transmitted to the display panel 230, so as to allow the display panel 230 to output the black frame.

### Fifth Embodiment

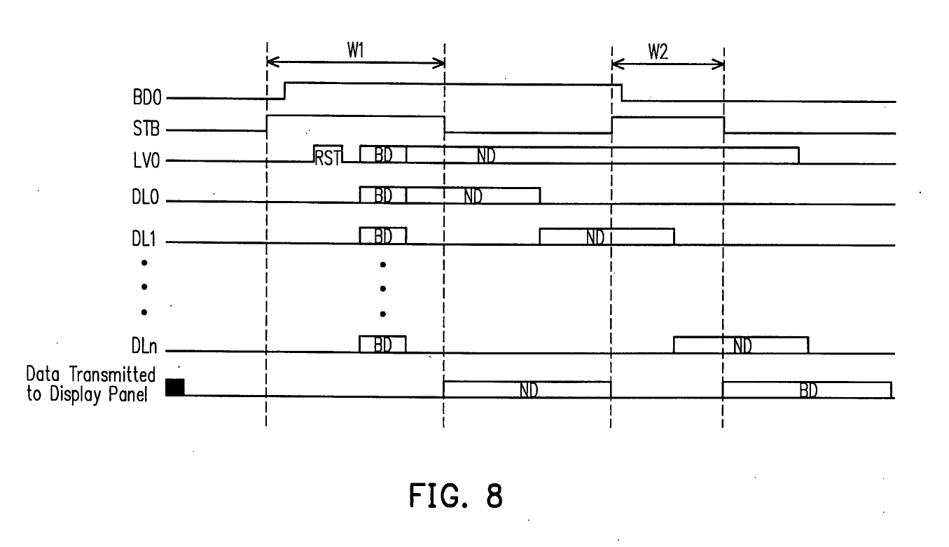

FIG. 8 is a signal sequence diagram of a driving method for the display according to a fifth embodiment of the present invention. Referring to FIGS. 2 and 8, the fifth embodiment provides a driving method similar with that of the fourth embodiment, while a difference therebetween is that the input register 214 of the fifth embodiment can be set with a delay time. When receiving the black frame data BD after the reset signal RST, the input register 214 holds for a delay time and thereafter determines that the received data is the normal frame data ND. As such, the current embodiment eliminates the need for different reset signals RST for allowing the input register 214 to determine whether the received data are black frame data BD or normal frame data ND.

### Sixth Embodiment

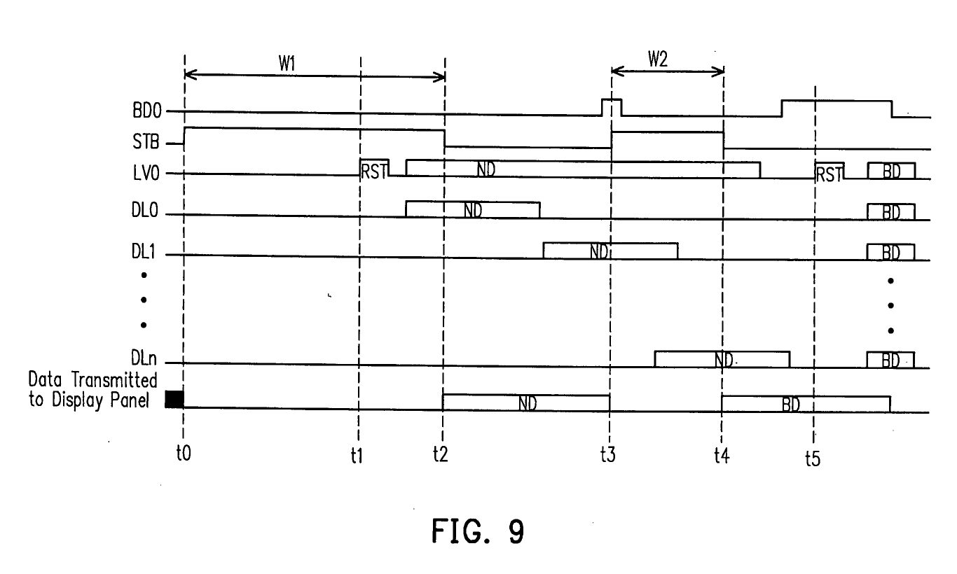

FIG. 9 is a signal sequence diagram of a driving method for the display according: to a sixth embodiment of the present invention. Referring to FIGS. 2 and 9 together, the sixth embodiment is similar with the fourth embodiment, in that when the clock sequence control unit 212 detects that the trigger signal STB and the black frame data output signal BDO are not both enabled at the detecting time t0, the clock sequence control unit 212 detects the status of the transmission line LV0.

However, the sixth embodiment differs from the fourth embodiment in that when detecting the reset signal RST, the clock sequence control unit 212 determines that the next data transmitted immediately after the reset signal on the transmission line LV0 would be the normal frame data ND, and when receiving the normal frame data ND, the clock sequence control unit 212 transmits the normal frame data ND to the input register 214, and later transmits the normal frame data ND to the output register 216 at a predetermined time. Likewise, the time period from t0 at which the trigger signal STB is enabled to t2 at which the trigger signal STB is disabled is defined as the first operation period W1.

Further, at the detection time t3, if the clock sequence control unit 212 detects that the trigger signal STB and the black frame data output signal BDO are both enabled, then the clock sequence control unit 212 waits for another reset signal RST. If at time t5, the clock sequence control unit 212 detects another reset signal RST on the transmission line LV0, the clock sequence control unit 212 then determines that the next data transmitted immediately after the reset signal on the transmission line LV0 would be the black frame data. Similarly, when receiving the black frame data BD, the clock sequence control unit 212 transmits the black frame data BD to the input register 214, and later transmits the black frame data BD to the output register 216 at a predetermined time. Likewise, the time period from t3 at which the trigger signal STB is enabled to t4 at which the trigger signal STB is disabled is defined as the first operation period W2.

Identical with that of the fourth embodiment, the output register 216 of the current embodiment transmits the normal frame data ND in sequence to the corresponding data lines. However, in the current embodiment, the black frame data BD are transmitted to the data lines DL[0:n] in a way of synchronous transmission. In such a way, the display panel 230 is adapted to display normal frames when the first operation period terminates, and display black frames when the second operation period terminates.

### Seventh Embodiment

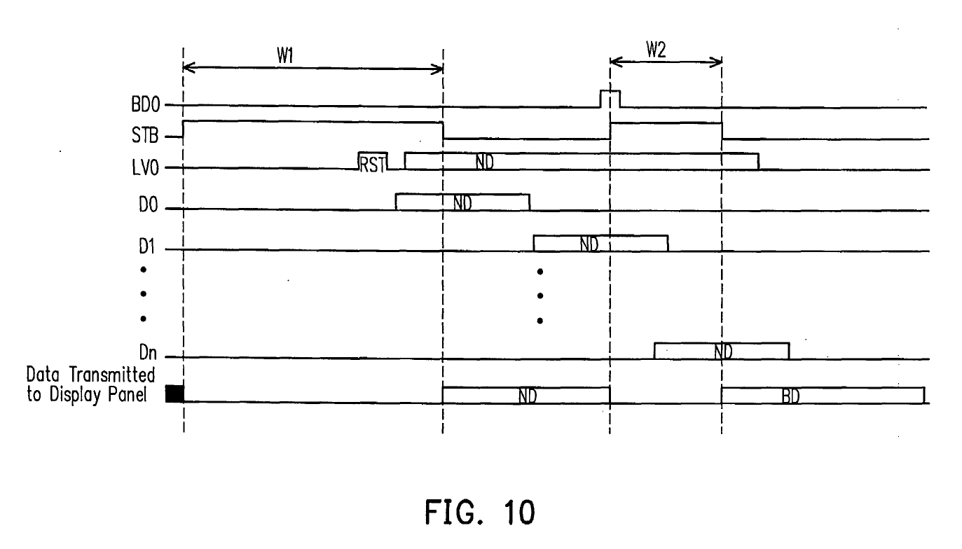

FIG. 10 is a signal sequence diagram of a driving method for the display according to a seventh embodiment of the present invention. Referring to FIGS. 2 and 10, similar to the foregoing embodiments, according to the seventh embodiment of the present invention, if the clock sequence control unit 212 detects at the detecting time t0 that the trigger signal STB and the black frame data output signal BDO are not both enabled, the trigger signal STB enters the first operation period W1 from t0 to t1. If the clock sequence control unit 212 detects that a reset signal RST is enabled on the transmission line during the first operation period W1, the clock sequence control unit 212 determines that the next data transmitted immediately after the reset signal on the transmission line LV0 would be the normal frame data ND. When receiving the normal frame data ND, the clock sequence control unit 212 transmits the normal frame data ND to the input register 214. The input register 214 transmits the normal frame data ND to the output register 216 at a suitable time point.

According to an aspect of the current embodiment, the black frame data BD can be transmitted to the output register only when the display enters a vertical blanking period. Similarly, the display panel 230 is adapted to receive the normal frame data ND when the first operation period terminates, and thus displaying the normal frame. And, the display panel 230 is also adapted to receive the black frame data BD when the second operation period terminate, and thus displaying the black frame.

### Eighth Embodiment

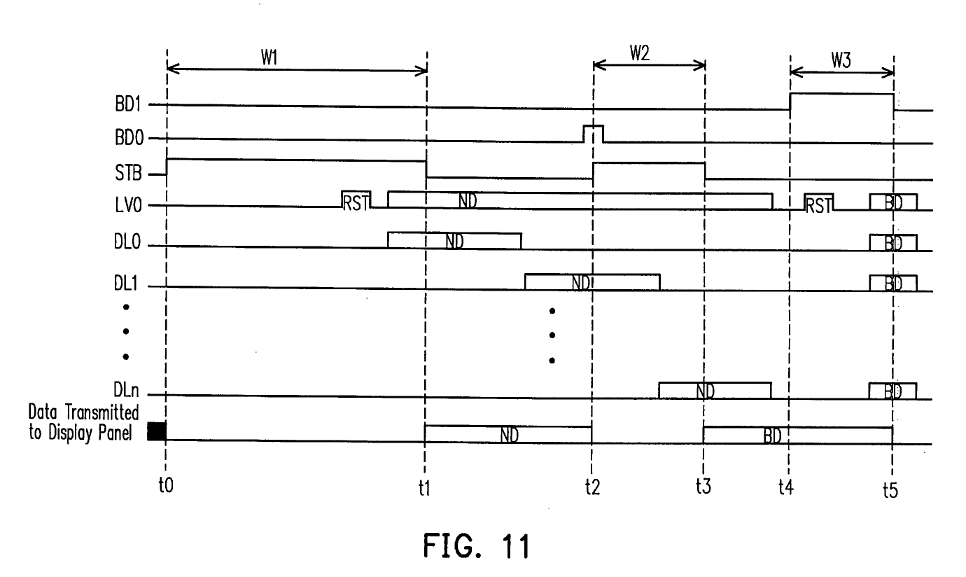

FIG. 11 is a signal sequence diagram of a driving method for the display according to an eighth embodiment of the present invention. Referring to FIGS. 2 and 11, according to the eighth embodiment of the present invention, the clock sequence control unit 212 receives not only the black frame data output signal BDO, but also a black frame data input signal BDI. If the clock sequence control unit 212, at time t0, detects that the trigger signal STB and the black frame data output signal BDO are not both enabled, the clock sequence control unit 212 waits for the reset signal RST on the transmission line LV0. The time period from t0 at which the trigger signal STB is enabled to t1 at which the trigger signal STB is disabled is defined as the first operation period W1.

If, for example, the clock sequence control unit 212 receives the reset signal RST during the first operation period W1, it can be determined that the next data transmitted immediately after the reset signal on the transmission line LV0 would be the normal frame data ND. When receiving the normal frame data ND, the clock sequence control unit 212 transmits the normal frame data ND to the input register 213. The input register 214 then transmits the normal frame data ND to the output register 216 at a suitable time point.

According to an aspect of the embodiment, the time period from t4 at which the black frame data input signal BDI is enabled to t5 at which the black frame data input signal BDI is disabled is defined as a third operation period W3. If, the clock sequence control unit 212 detects from the transmission line LV0 that the reset signal RST is again enabled during the third operation period W3, it is determined that the next data transmitted immediately after the reset signal on the transmission line LV0 would be the black frame data BD. When receiving the black frame data BD, the clock sequence control unit 212 transmits the black frame data BD to the input register 214, and transmits the same to the output register 216 at a suitable time point.

Similarly, the second operation period W2 defined hereby is the time period from t2 at which the black frame data output signal BDO is enabled to t3 at which the black frame data output signal BDO is disabled. As such, the clock sequence control unit 212 is adapted to control the output register 216 during the first operation period W1 to transmit the normal frame data ND in sequence to the display panel 230, so as to allow the display panel 230 to display the normal frame when the first operation period W1 terminates. Further, the clock sequence control unit 212 is also adapted to control the output register 216 during the second operation period W2 to synchronously transmit the black frame data BD to the display panel 230, so as to allow the display panel 230 to display the black frame when the second operation period terminates.

In summary, the present invention relies upon statuses of the trigger signal and the black frame data output signal for controlling the operations of the output register and the input register, so as to prevent misoperation caused by noises. Further, the present invention is adapted to control lengths and intervals of the first operation period and the second operation period, so as to be capable of display frames at any time with any gray level, e.g., a black frame, under a mini-LVDS transmission protocol.

It will be apparent to those skilled in the art that various modifications and variations can be made to the structure of the present invention without departing from the scope or spirit of the invention. In view of the foregoing it is intended that the present invention cover modifications and variations of this invention provided they fall within the scope of the following claims and their equivalents.

What is claimed is:

1. A driving method for a display having a plurality of data lines, comprising:
providing a black frame data output signal and a trigger signal;
receiving at least one of a plurality of normal frame data and a black frame data from a receiving terminal;
outputting the normal frame data from an output terminal when the trigger signal is enabled, and the black frame data output signal is not enabled, and when the trigger signal changes its status so as to allow the display to display the normal frame; and
outputting the black frame from the output terminal when both of the trigger signal and the black frame data output signal are enabled, and when the trigger signal changes its status so as to allow the display to display the black frame, and sustaining a status of the receiving terminal.

2. The driving method according to claim 1, further comprising:
determining the trigger signal as entering a first operation period if the trigger signal is enabled while the black frame data output signal is not enabled, and detecting whether there is a reset signal being transmitted on a transmission line after the first operation period terminates, wherein the transmission line transmits the normal frame data via serial transmission;
receiving a next data transmitted on the transmission line after the reset signal being disabled if it is detected that the reset signal is enabled, wherein the next data serves as the normal frame data;
transmitting the received normal frame data to corresponding data lines respectively when the first operation period terminates, so as to allow the display to display the normal frame; and
determining the trigger signal while entering a second operation period when both of the trigger signal and the black frame data output signal are enabled at a same time, wherein when the second operation period terminates, the black frame data are transmitted to the data lines in sequence, so as to allow the display to display the black frame.

3. The driving method according to claim 1, further comprising:
determining the trigger signal while entering a first operation period if the trigger signal is enabled while the black frame data output signal is not enabled, and detecting whether there is a reset signal being transmitted on a transmission line, wherein the transmission line serially transmits the normal frame data;
determining the next data transmitted immediately after the reset signal on the transmission line are the normal frame data if it is detected that the reset signal is enabled in the first operation period;
transmitting the received normal frame data to corresponding data lines respectively, so as to allow the display to display the normal frame when the first operation period terminates;
determining the trigger signal while entering a second operation period when both of the trigger signal and the black frame data output signal are enabled at a same time, and detecting whether the reset signal is enabled again;
determining the next data transmitted immediately after the reset signal on the transmission line are the black frame data if the reset signal is enabled again; and
transmitting the black frame data to the data lines, so as to allow the display to display the black frame when the second operation period terminates.

4. The driving method according to claim 1, further comprising:
determining the trigger signal as entering a first operation period if the trigger signal is enabled while the black frame data output signal is not enabled, and detecting whether there is a reset signal being transmitted on a transmission line, wherein the transmission line serially transmits the normal frame data and the black frame data and the black frame data;
determining that the next data transmitted immediately after the reset signal are the black frame data and the normal frame data in that sequence if it is detected that the reset signal is enabled during the first operation period;
transmitting the received normal frame data to corresponding data lines respectively, so as to allow the display to display the normal frame when the first operation period terminates;
determining the trigger signal as entering a second operation period when both of the trigger signal and the black frame data output signal are enabled at a same time; and
transmitting the black frame data to the data lines, so as to allow the display to display the black frame when the second operation period terminates.

5. The driving method according to claim 1, further comprising:
determining the trigger signal while entering a first operation period if the trigger signal is enabled while the black frame data output signal is not enabled, and detecting whether there is a reset signal being transmitted on a transmission line, wherein the transmission line is adapted for serially transmitting the normal frame data and the black frame data;
determining that the next data transmitted immediately after the reset signal on the transmission line are the black frame data if it is detected that the reset signal is enabled during the first operation period;
waiting for the reset signal to be enabled once again when the transmission of the black frame data is completed;
determining that the immediately next data transmitted on the transmission line are the normal frame data when the transmission of the black frame data is completed, and the reset signal is enabled again;
determining the trigger signal as entering a second operation period when both of the trigger signal and the black frame data output signal are enabled at a same time;
transmitting the normal frame data to the data lines in sequence, and allowing the display to display the normal frame when the first operation period terminates; and
synchronously transmitting the black frame data to the data lines, and allowing the display to display the black frame when the second operation period terminates.

6. The driving method according to claim 1, further comprising:
determining the trigger. signal as entering a first operation period if the trigger signal is enabled while the black frame data output signal is not enabled, and detecting whether there is a reset signal being transmitted on a transmission line, wherein the transmission line is adapted for serially transmitting the normal frame data and the black frame data;
determining that the next data transmitted immediately after the reset signal on the transmission line are the black frame data if it is detected that the reset signal is enabled during the first operation period, and starting to count time;
determining that the data being transmitted on the transmission line are the normal frame data after the black frame data being transmitted for a delay time;
determining the trigger signal as entering a second operation period when both of the trigger signal and the black frame data output signal are enabled at a same time;
transmitting the normal frame data to the data lines in sequence, and allowing the display to display the normal frame when the first operation period terminates; and
synchronously transmitting the black frame data to the data lines, and allowing the display to display the black frame when the second operation period terminates.

7. The driving method according to claim 1, further comprising:
determining the trigger signal as entering a first operation period if the trigger signal is enabled while the black frame data output signal is not enabled, and detecting whether there is a reset signal being transmitted on a transmission line, wherein the transmission line is adapted for serially transmitting the normal frame data and the black frame data;
determining that the next data transmitted immediately after the reset signal on the transmission line are the normal frame data if it is detected that the reset signal is enabled during the first operation period;
waiting for the reset signal to be enabled once again when the transmission of the normal frame data is completed;
determining that the immediately next data transmitted on the transmission line are the black frame data when the transmission of the black frame data is completed, and the reset signal is enabled again;
determining the trigger signal as entering a second operation period when both of the trigger signal and the black frame data output signal are enabled at a same time;
transmitting the normal frame data to the data lines in sequence, and allowing the display to display the normal frame when the first operation period terminates; and
synchronously transmitting the black frame data to the data lines, and allowing the display to display the black frame when the second operation period terminates.

8. The driving method according to claim 1, further comprising:
determining the trigger signal as entering a first operation period if the trigger signal is enabled while the black frame data output signal is not enabled, and detecting whether there is a reset signal being transmitted on a transmission line, wherein the transmission line serially transmits the normal frame data and the black frame data;
determining that the next data transmitted immediately after the reset signal on the transmission line are the normal frame data if it is detected that the reset signal is enabled during the first operation period;
transmitting the normal frame data to the data lines in sequence, and allowing the display to display the normal frame when the first operation terminates;
transmitting a black frame data during a vertical blank period;
determining the trigger signal as entering a second operation period when both of the trigger signal and the black frame data output signal are enabled at a same time; and
allowing the display to display the black frame according to the black frame data when the second operation period terminates.

9. The driving method according to claim 1, further comprising:
providing a black frame data input signal, wherein the black frame data input signal is enabled in a period that is a third operation period;
determining the trigger signal as entering a first operation period if the trigger signal is enabled while the black frame data output signal is not enabled, and detecting whether there is a reset signal being transmitted on a transmission line, wherein the transmission line serially transmits the normal frame data and the black frame data;
determining that the next data transmitted immediately after the reset signal on the transmission line are the normal frame data if it is detected that the reset signal is enabled during the first operation period;
transmitting the normal frame data to the data lines in sequence, and allowing the display to display the normal frame when the first operation period terminates;
determining that the next data transmitted immediately after the reset signal on the transmission line are the black frame data if it is detected that the reset signal is enabled during the third operation period;
synchronously transmitting the black frame data to the data lines;
determining the trigger signal as entering a second operation period when both of the trigger signal and the black frame data output signal are enabled at a same time; and
allowing the display to display the black frame according to the black frame data when the second operation period terminates.

10. A data control circuit for use in a display, comprising:
a clock sequence control unit for receiving a trigger signal, a black frame data output signal, and a plurality of normal frame data, and outputting a control signal;
an input register, electrically coupled to the clock sequence control unit, for receiving the normal frame data; and
an output register, electrically coupled to the input register, for outputting the normal frame data or the black frame data according to the control signal.

11. The data control circuit according to claim 10, wherein when the trigger signal and the black frame data output signal are not both enabled at a same time, the clock sequence control unit controls the output register to output normal frame data when the trigger signal changes its status.

12. The data control circuit according to claim 10, wherein when the trigger signal and the black frame data output signal are both enabled, and when the trigger signal changes its status, the clock sequence control unit controls the output register to output black frame data, and maintains the output register unchanged from its present status.

13. The data control circuit according to claim 10, wherein the output register receives a predetermined value serving as the black frame data.

14. The data control circuit according to claim 10 further comprising a black frame data register coupled to the output register for temporally storing the black frame data.

15. The data control circuit according to claim 12, wherein the clock sequence control unit receives a black frame data input signal, and determines whether to receive the black frame data according to a status of the black frame data input signal.

16. A display, comprising:
a data control circuit for receiving a trigger signal and a black frame data. output signal;
a display panel;
a plurality of data lines for coupling the data control circuit and the display panel; and
wherein when the trigger signal and the black frame data output signal are not both enabled at a same time, the data control circuit controls the display panel to display a normal frame when the trigger signal changes its status; and when the trigger signal and the black frame data output signal are both enabled at a same time, the data control circuit controls the display panel to display a black frame when the trigger signal changes its status.

17. The display according to claim 16, wherein the data control circuit comprises:
a clock sequence control unit adapted for receiving the trigger signal, the black frame data output signal, and adapted for serially receiving a plurality of normal frame data;
an input register, electrically coupled to the clock sequence control unit, for receiving the normal frame data;
an output register, electrically coupled to the input register for receiving the normal frame data, and coupled to the display panel via the data lines; and
wherein when the trigger signal and the black frame data output signal are not both enabled at a same time and when the trigger signal changes its status, the clock sequence control unit controls the output register to output normal frame data to the display panel for allowing the display panel to display the normal frame; and when the trigger signal and the black frame data output signal are both enabled at a same time, and when the trigger signal changes its status, the clock sequence control unit controls the output register to output black frame data to the display panel, for displaying the black frame.
